(19) United States
(12) Patent Application Publication
(10) Pub. No.: US 2005/0116087 A1
(43) Pub. Date: Jun. 2, 2005

(54) Aircraft converts drag to lift

(76) Inventor: John Splawn Page JR., Lake Forest, CA (US)

Correspondence Address: JOHN SPLAWN PAGE, JR., 25092 FARTHING STREET #61, LAKE FOREST, CA, 92630-4034, US

(21) Appl. No.: 10/460,275

(22) Filed: Jun. 11, 2003

(51) Int. Cl. B64C 27/22

(52) U.S. Cl. 244/10

(57) ABSTRACT

An aircraft that has a fuselage that has a majority of its frontal surface areas that strike air angled to deflect air down and cause an upward lift on said fuselage and a propulsion means attached to the fuselage on a different angle than the angle of the fuselage thereby causing the bottom of the fuselage to have an angle of attack into the wind like a conventional wing thereby contributing to the lift of the aircraft.

### BACKGROUND

This invention relates to aircraft design as it affects speed, fuel consumption, the flying range and the horizontal space that a plane takes up on the deck of an aircraft carrier or at an airport terminal docking site.

When an aircraft pushes the front surfaces of its fuselage and wings through the air a very substantial amount of drag is created. It accounts for a high percent of the total power requirement of an aircraft.

There are several forms or types of drag on an aircraft. The type that applicant's is especially dealing with is the form drag, also called profile drag. Military fighter aircraft are designed with needle nose front ends to minimize this kind of drag. However the larger aircraft such as the famous Lockheed C-130 Hercules, affectionately known as “Fat Albert”, the Boeing 747, and 737-8AS, the Navy work horse S3 Viking and even the new Boeing 777, all have massive profile form drag.

The front of the fuselage on these aircraft are only rounded slightly to decrease drag. They are designed to be almost neutral with respect to the force of the air contacting the front surfaces that push it up or down. The direction that the air is deleted off of the front surfaces of the fuselage is very important because they cause either up thrust or a down thrust on those surfaces. When the frontal surfaces of a fuselage are angled and rounded equally up, down and all around it is neutral aerodynamically. All aircraft have windshields that are sloped and as the wind strikes them, the air is deflected up and the windshield and fuselage is pressured down.

Because the wind-shield has to be there, it results in a net down force on the fuselage of every aircraft that can be observed. Even the most high tech fighter planes have more surface area exposed to downward impact than upward impact.

The large planes have huge wings to create lift and they ignore the potential contribution that the fuselage can contribute to lift. They just live with the drag and put in enough power to deal with it.

The propulsion means and the fuselage on conventional aircraft are affixed to each other at the same angle as each other. The wings are attached to the fuselage at a different angle to provide an angle of attack into the wind to create the lift needed. They depend totally on the wings and a little from the tail for lift.

The upward angle of the wing is referred to as the angle of attack into the air. When the wing is attached to the fuselage on a different angle than the fuselage, it is referred to as the angle of incidence. The engines and their thrust or pull are mounted on the same alignment as the fuselage. This is an important distinction between the present day aircraft and applicant's invention.

The huge amounts of drag that conventional aircraft have to contend with is the reason that applicant believes he can make some improvement in speed and or fuel consumption.

### PRIOR ART

Applicant's has not been able to find anything in the prior art history of aircraft that is similar to or has the features that applicant's invention has.

Applicant's references the following web cites to show the large areas and bluntness of the fuselages on prominent aircraft flying today.
http://www.phototeleis.com/aviation/S3.htm,
http://www.worldaircorps.com/tmpages/c2072s3r.htm
http://www.chinfo.navy.mil/navpalib/factfile/aircraft/air-s3b.html
http://webcom.com/˜amraam/s3.html
http://www.history.navy.mil/planes/ch53.htm
http://www.aviapress.com/viewonekit.htm? KRR-200010
http://www.airwar.ru/aircraftnowe.html

### OBJECTS AND ADVANTAGES

Therefore the above points about air drag are an important part of the subject of this invention.

Some of the objects and advantages and of this invention are to provide an aircraft that will fly faster or consume less fuel and have an extended flying range. It will also take up less horizontal space on the deck of an aircraft carrier or at an airport terminal docking site. Applicant's accomplishes his goals by converting drag to lift. This allows for wings to be shorter and take up less lateral space.

In contrast to conventional aircraft that have the alignment of the fuselage and propulsion means on the same alignment, the applicant's invention has the wings on the same alignment as the fuselage. The propulsion means is the thing that is affixed to the fuselage at a different angle: a down angle.

This feature makes it possible to make a fuselage function as a wing. That important feature along with an unconventional shaped fuselage and wings create a structure that will convert a substantial amount of the costly frontal profile form drag into productive lift. Present aircraft technology is overlooking this potential of using the fuselage as a significant contributor to the lift of the aircraft.

The Lockheed Martin's S-3 Viking—called the “Swiss Army Knife of Naval Aviation”—remains one of the most successful designs in carrier aircraft history.

The following is a comparison of the S3 Viking to applicant's design. To compare the S3 Viking to applicant's invention the same square feet of fuselage frontal area is used on each. Each has a fuselage of 77 inches wide by 96 inches high; the square foot of area is 51 feet. The cruising speed of the S3 Viking is 380 knots per hour. The formula for air drag is:

0.0034×1.5×380 knots×380 knots=736 lb. per square foot multiplied by the area of 51 square feet; it results in 37,536 lb. frontal drag less the rounding of the fuselage nose. Deduct 10% for slight rounding and the net drag is 33,782 lb. on the S3 Viking fuselage. The S3 Viking wings have approximately 36 square feet of frontal area times 736 lb. per square foot equals 26,496 lb. of wing drag minus about 10% for rounding equals 23,846 net wing drag. The total profile drag on the S3 Viking is approximately 57,628 lb. when flying at 380 knots per hour.

Comparing applicant's design to the S3 Viking and using the same frontal dimensions and surface areas but dividing the areas between areas that deflect air down and areas that deflect air up. On applicant's aircraft the wind shield area is rounded and angled at 45 degrees on part of it and 30 degrees on part of it greatly minimizing the thrust on it so that the net down thrust on the wind shield is approximately 1913. On the front of the fuselages from the bottom of the windshield down and back to the flat bottom of the fuselages is 34 square feet of area. The 34 feet times the 736 lb. is 25,024 lb. It is rounded and angled at about a 25-degree angle. Deduct 75% of the 25,024 and it results in 6,256 lb. fuselages drag. This is now lift as well as profile drag because the deflection of air is down resulting in lift. The drag on the windshield is 1,913 and that has a downward push. Therefore deduct the 1,913 from the 6,256 results in 4,343 lb. net lift from the frontal surfaces of the fuselage only. Combining the two amounts of fuselage drag of 6,256 and 1,913 results in 8,169 lb of total drag by the frontal surfaces of applicant's fuselage of which 4,343 lb is lift.

To calculate the frontal area of the wings that are cutting through the air, the full width of the wing span is 16 feet (192 inches). Then deduct the width of the fuselage that has been calculated separately which is 77 inches because it was part of the 16 ft width. The net frontal wing surface is 115 inches times the thickness of the wing that is 7 inches. The shape of the front of applicant's wing is not like conventional wings that have a rounded bull nose shape, which causes lots of drag. Applicant's wing is flat on top no hump and on the very front leading edge it sharply angles back and down at a 45-degree angle. This reduces the drag by 50 percent. That angle is 9.650 inches long. Therefore, the calculation is 115 inches times 9.650 equals 1,109.75 divided by 144 square inches is 7.7 square feet of surface area that is drag area and lift area.

Therefore the frontal surface drag on applicant's wing is: air impacting a surface at 380 knots per hour is 736 lb per square foot times 7.7 square feet results in 5,667. The angled surface of 45-degrees reduces it to 2,833 lb. of drag but that is lift also. The total drag for this invention is 2,833 plus 8,169 results in 11,002 total drag. Of this total drag, the amount of it that is pure lift is 2,833 plus 4,343 equal 7,176 lb. net lift.
Total profile drag on the S3 Viking is 57,628 lb. and no lift.
Total profile drag on this invention is 11,002 lb. 4,850 of it is lift.
The S3 has 46,626 lb. more total drag than applicant's design.
The wing area of the S3 Viking is 598 square feet. The wing area of this invention has the width of 16 feet by 43 feet long for and aft. That is 688 square feet of wing area. That is 90 feet more area than the S3 Viking and with less profile.

The bottom of applicant's aircraft design is approximately flat and hangs down from the propulsion means so that an angled surface is presented forward to contact the wind at varying degrees of angle. The engines have an adjusting means feature. The engines fly level and the rest of the aircraft is hanging at an angle.

The above numbers deal with just the frontal profile drag. There is also drag on the bottom of the S3 wings (598 square feet) and on the 688 feet of wing and fuselage. There are other types of drag like friction on both type aircraft however since it is not a large amount is not dealt with here.

### SUMMARY OF THE INVENTION

The unique feature of applicant's invention is that the propulsion means that are affixed to the fuselage are on a different angle of alignment than the fuselage. They are mounted on a downward angle so that when the engines are thrusting or pulling level to the ground, the fuselage is angled up like a normal wing is, thereby creating lift like the wing normally does. The wings that may be attached to the fuselages are attached on the same alignment, as the fuselage so there is no angle of attack that the wings have that the fuselage does not have.

Another unique feature of applicant's invention is that since the fuselage is used as lifting means, the bottom and top of it are important aspects of the lift function. Applicant's design shows the top and bottom of the fuselage with flat surfaces from side to side.

The bottom surface of the fuselage that is exposed to the impact of the air that causes lift has a continuous surface from the front to the back so that the air that strikes the bottom of the fuselage at the front has a continuous surface to push on to maintain a constant lifting pressure on its bottom surface all the way to the back. In other words, the surface does not recede away from a straight line. The bottom of conventional aircraft do recede away from a straight line and they angle up to a higher elevation terminating in a smaller cross-section at the tail.

The top of the fuselage on this invention runs parallel to the bottom until it starts tapering down toward the bottom end of the fuselage where the top and bottom meet and form the trailing edge like a conventional wing does and where there may or may not be ailerons. The bottom surface does not taper up to meat the top. Only the top tapers down to meet the bottom. The top functions as a wing. The bottom at the front is more like the bow of a boat that is skiing on the water. That is exactly what this fuselage is doing. It is skiing on the air and it is sucking the air above and behind it creating an additional pressure differential across its fuselage just like conventional wings does.

Applicant's design shape of the wind shield canopy keeps the surfaces that cause wind to be deflected upward to a minimum. Almost immediately the front surfaces of the fuselage below the wind shield canopy starts angling down and back so that the surfaces are deflecting air down. Then that angle intersects with the bottom surface of the fuselage and bends to continue on an inclined angle all the way to the back of the fuselage. Because the fuselage is moving through the air on an angle, its bottom surface continues to meet the frontal air and create lift.

Therefore in important goal of this aircraft is to have a fuselage that has a majority of its cross-sectional area that is subjected to the impact of static air striking its surfaces be inclined to cause air to be deflected down and an upward lift on the aircraft.

Another unique feature of applicant's invention is that the propulsion means is attached to an adjusting means, which is attached to the fuselage whereby the propulsion means can be adjusted to point downward and or upward. This allows the angle of attack of the bottom of the fuselage to be fine tuned adjusted to achieve the optimum angle of attack as air density changes at different altitudes, thereby optimizing performance and minimizing fuel consumption.

Another unique feature of applicant's invention is that the bottom of the fuselage or aircraft has air-barrier structures on each side extending down from the fuselage and extending longitudinally along the length of the fuselage or wings whereby they inhibit the higher pressure air on the bottom of the fuselage or wings from flowing off to the sides to equalize with the surrounding air.

Similarly the fuselage has air-barrier structures at each side extending up from the fuselage or aircraft and extending longitudinally along the length of the fuselage or aircraft whereby they inhibit the higher air pressure outside of the air-barrier from flowing into the low pressure area inside the air-barrier.

Another design feature of applicant's invention is that the front width profile dimension is approximately the same as the back width profile dimension as the drawing in FIG. 2 shows. The length of the wings longitudinally is longer than their width. Also the length of the whole structure is longer than the width of the structure.

### BRIEF DESCRIPTION OF DRAWINGS

FIG. 1 is a side view of the aircraft.

FIG. 2 shows the fuselage going down the middle taking up only about ⅓ of the width of the space between the air-barriers that are on each side. The rest of the width of the structure consists of the wings that extend out laterally like conventional wings do except that they are longer longitudinally than they are wide laterally. The sides of them extend in a straight line all the way back to the end of the structure.

FIG. 3 is a view from behind the structure looking through the tail section. It shows the fuselage and the air-barrier that extend up from the top of the fuselage on each side of the fuselage.

By contrast to FIG. 1, the FIG. 4 is a plan view looking down of the aircraft that shows the fuselage as extending all the way across the structure from air-barrier to air-barrier instead of just a narrow strip of fuselage down the middle.

FIG. 5 is a view from behind the structure looking through the tail section. It shows the height of the fuselage extending all the way across from air-barrier to air-barrier and no wings extending beyond the fuselage.

FIGS. 6 and 7 are the same as FIGS. 2 and 3 except that they show an additional wing on each side extending out even further than the other wings.

FIG. 8 is a side view of a propeller driven aircraft. It shows the air-barrier that extends up from the wing and the air-barrier that extends down from the wing.

FIG. 8 also shows the air-barrier extending up from the top of the fuselage and then extending down along the top of the fuselage almost to the tail. It also shows the air-barrier extending down from the bottom of the fuselage.

FIG. 9 shows a front view of the wing on the propeller aircraft with the air-barriers extending up and down from the tips of the wing.

FIG. 10 is a view that shows a wing construction design or fuselage wall construction design using square “U” channels that form series of hollow square tubes when welded toothier.

### DETAILED DESCRIPTION

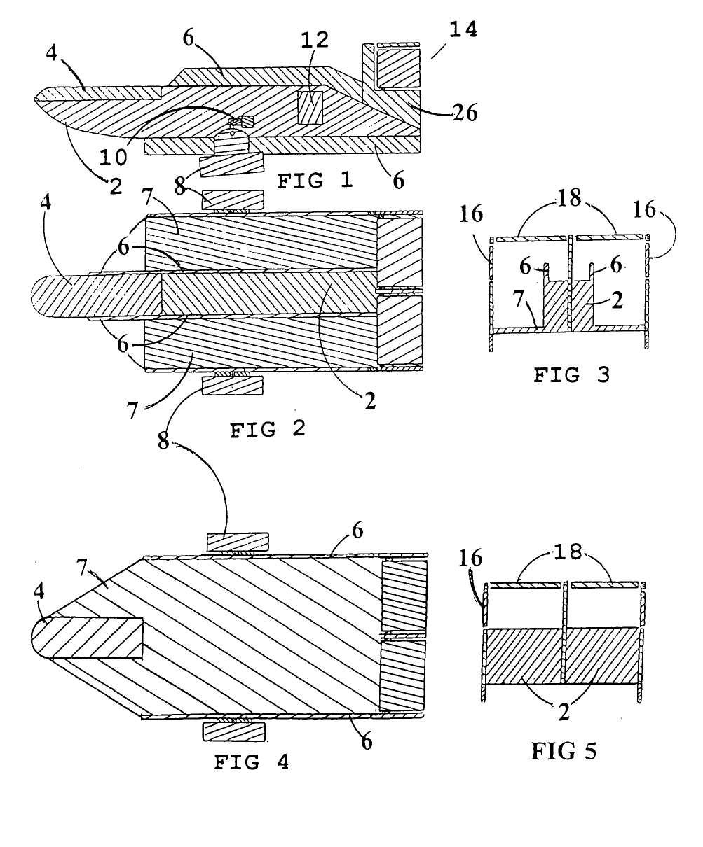

FIG. 1 is a side view of the aircraft and the fuselage 2. The top, bottom and sides of the fuselage 2 are all flat surfaces. These flat surfaces work well in cooperation with the air-barrier at the sides of the fuselage. The sides being flat give the fuselage lateral stability like the vertical stabilizer of the tail assembly 14 do. They also make it practical to have large flaps 12 operating out of the sides of the fuselage. They give additional turning control and extra slowing capability when landing on an aircraft carrier. FIG. 1 also shows the windshield canopy 4, the air-barrier 6 extending up from the top of the fuselage 2 and extending down from the bottom of the fuselage. Also shown is one of two jet engines 8 with a hydraulic adjusting means 10? It adjusts the up or down alignment of the engine, thereby controlling the direction of the thrust of the engines, one on each side, which adjusts the inclination of the fuselage which determines the amount of lift on the fuselage. The front of the fuselage 2 extends out beyond the wings 7 and tapers up from the bottom of the fuselage 2 on about a 60-degree angle but rounded. In FIG. 1 wings extend out from the bottom of the fuselage and they carry the jet engines 8. The thickness of the wings can vary. They may be needed for fuel storage but whatever thickness they have, they will be inclined on their front surfaces so that they deflect air down and create lift on the wing. This inclined surface would be approximately 3 to 5 degrees. If the wings are not needed for fuel storage, they could be constructed with a hollow square tube design described herein and in FIG. 7.

FIG. 3 is a view from behind the structure looking through the tail section 14. It shows the width of the fuselage 2 and the air-barriers 6 extending up from the top of the fuselage 2 and the wings 7 extending out from the bottom of the fuselage 2. The ailerons 18 and the rudders 16 are also shown.

FIG. 4 is a plan view looking down of the aircraft that shows the fuselage as extending all the way across the structure from air-barrier 6 to air-barrier 6. The front of this form of fuselage 2 is rounded and angled from left to right and from bottom upward to the bottom of the windshield so that it is rounded, angled and pointed like the bow of a boat. This front bottom surface area is working to lift the fuselage 2. This view shows the height of the fuselage extending all the way across the structure from air-barrier 6 to air-barrier 6 and FIG. 1 illustrates how FIG. 4 would appear from the side. That is the correct side view for FIG. 4. No wings are extending beyond the sides of this fuselage 2.

By contrast the FIG. 2 shows the fuselage going down the middle taking up only about ⅓ of the width of the space between the air-barriers 6. The rest of the width of the structure shows the wings 7 that extend out laterally from the fuselage like conventional wings do except that they are longer longitudinally than they are wide laterally. These wings are basically rectangular and as such they present less frontal surface area to plow through the air than wings that extend way out to get the surface area required for lift. A rectangular wing gives more surface area for lift and less frontal surface exposure to impacting air and therefore less drag.

The air-barriers 6 are at each of the far sides of the wings. The front width profile dimension is approximately the same as the back width profile dimension. This is true for FIGS. 1, 2 and 4.

FIG. 5 is a view from behind the structure looking through the tail section. It shows the fuselage 2 extending all the way across from one side of the structure to the other side. The air walls 6 that extend up from the top of the fuselage 2 are hidden behind the vertical support columns 26 shown in FIG. 1 for the twin rudders 16.

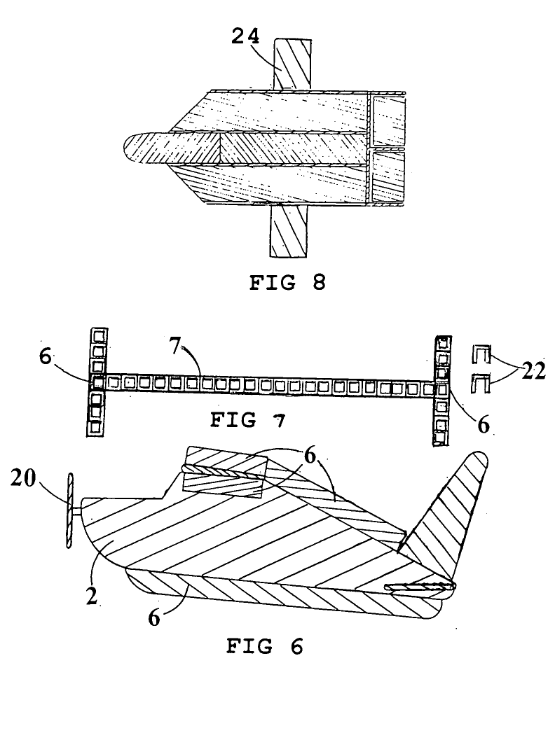

FIG. 6 is a side view of a propeller driven aircraft.

It shows the air-barriers 6 that extend up from the wing 7 and the air-barriers 6 extending down from the wing 7 and the air-barriers 6 extending up from the top of the fuselage 2, one on each side. It extends along the top of the fuselage 6 almost down to the tail assembly 14. It also shows the air-barriers 6 extending down from the bottom of the fuselage 2. The bottom of the fuselage 2 and the air-barrier 6 is angled relative to the propeller 20. Therefore the bottom of the fuselage 2 is skiing on the air and creating lift as it moves forward through the air and on the air while the propeller pulls the engine on a level plane. Because the top of the fuselage tapers down to the end of the fuselage, it causes a displacement of air in the form of suction and therefore an increased pressure differential and thus lift by the fuselage body.

FIG. 7 shows a front view of a wing that could be on a propeller type aircraft or a glider with the air-barriers 6 extending up and down from the wing. This view also shows a wing construction design or fuselage wall construction design. It is fabricated so that it is a series of hollow square tubes. The material used is a square “U” shaped channel that is welded together. They are shown with numbers 22 as they are individually before they are welded together. The purpose of this construction is that it greatly reduces profile drag because the air can flow through them rather than be buffeting or deflecting the air up or down. This construction is very strong. The vertical support for the tail rudder and the rudder itself could be made this way on other planes as well. Even the walls of the fuselage could be made this way and let the air flow through them. This would reduce the total cross-section of the fuselage. It would be especially good for the flat walls as described in applicant's fuselage design. Who needs windows?

1. The invention of an aircraft that has a fuselage that has a majority of its front facing surface areas angled to cause the air to be deflected down.

2. The invention of claim 1 that has a wing that has its leading edge surfaces areas angled so that they cause the air to be deflected down.

3. The invention of an aircraft that comprises:
a) fuselage
b) a propulsion means connected to said fuselage at a different angle than the bottom surface of the fuselage, thereby giving the fuselage an upward angle of attack into the air when said propulsion means is thrusting or pulling at a different angle
c) lift creating means on said fuselage.

4. The invention of claim 3 whereby said propulsion means is connected to said fuselage by an adjusting means that joins the two said members into an operational relationship that allows the adjusting means to change the angle of the propulsion means relative to the angle of the bottom surface of the fuselage.

5. The invention of claim 3 whereby the bottom surface of said fuselage has air-barrier structures on each side extending down and extending longitudinally along the length of the fuselage whereby they inhibit the higher pressure air on the bottom of the fuselage from flowing off to the sides to equalize with the surrounding air.

6. The invention of claim 3 whereby the top of said fuselage has air-barrier structures attached at each side and extending up and extending longitudinally along the length of the fuselage whereby they inhibit the higher air pressure outside of the air-barriers from flowing into the low pressure area inside of the air-barriers.

7. The invention of claim 3 that has air-barrier structures extending up from the wings and extending down from the wings at each end or side and they extend longitudinally along the length of the wings fore and aft whereby on the bottom side of the wings the air-barriers inhibit the higher air pressure on the wing from flowing off into the low pressure area outside the air-barriers and they inhibit the higher air pressure outside the air-barriers from flowing into the low pressure area inside the air-barriers that exist on top of the wing.

8. The invention of claim 3 whereby said fuselage has wings extending out from it and on the bottom surface of said wings air-barrier structures are attached on each side and extending down from the wing and extending longitudinally fore and aft along the side of the wing whereby they inhibit the higher pressure air on the bottom of the wing from flowing off to the sides to equalize with the surrounding air.

9. The invention of claim 3 whereby the top of said wings have air-barrier structures attached at each side and extending up from the wings and extending longitudinally fore and aft along the length of the wings whereby they inhibit the higher air pressure outside of the air-barriers from flowing into the low pressure area inside the air-barriers.

10. The invention of claim 3 whereby said lift creating means is basically rectangular and has front facing surface leading edges that make up not less than 89% of the total widest width of the lift creating means.

11. The invention of claim 3 whereby the length of the wings longitudinally are longer than their width.

12. The invention of claim 3 whereby the sides of said fuselage are approximately flat from top to bottom.

13. The invention of claim 3 whereby the bottom of said fuselage is approximately flat from one side to the other side.

14. The invention of claim 3 whereby the top of said fuselage is approximately flat from one side to the other side.

15. The invention of claim 3 whereby the floor of the passenger section of said fuselage is inclined at a different angle than the bottom outside surface of the fuselage.

16. The invention of claim 3 whereby the passenger section of said fuselage has one or more steps in its floor to allow for maintaining a level floor for the passengers to walk on while the propulsion means is inclined at a different angle.

17. The invention of an aircraft that incorporates a structural material that consists of sheets of material processed together to form four spaced apart walls with a hollow space within the four walls and there being a series of such four sided structures side by side sharing a common wall between each of them whereby an elongated structure is formed that will allow air to pass through the hollow spaces, thereby the elongated structure is suitable to be used as a wing, a wall, a structural column, an air-barrier or any structural supporting member on an aircraft.

18. The invention of claim 17 whereby an aircraft wing is constructed of the material of claim 17 resulting in an aircraft with very low wing profile drag because the air can flow through the hollow spaces of the material.
